(19) United States
(12) Patent Application Publication
(10) Pub. No.: US 2009/0236910 A1
(43) Pub. Date: Sep. 24, 2009

(54) Point of use and network control of electrical appliances and method

(76) Inventors: Jose Luiz Yamada, Houston, TX (US); Mark A. Lewis, Houston, TX (US)

Correspondence Address: Wisner & Associates, Suite 400, 1177 West Loop South, Houston, TX, 77027, US

(21) Appl. No.: 12/284,394

(22) Filed: Sep. 22, 2008

Related U.S. Application Data
(63) Continuation-in-part of application No. PCT/US08/03845, filed on Mar. 24, 2008.

(51) Int. Cl. H02J 3/00; H05B 37/02

(52) U.S. Cl. 307/40; 315/154

(57) ABSTRACT

A system and method for targeted, remote switching of electrical appliances. The system includes a transmitter for selectively producing a directional output signal and a receiver for detecting the directional output signal from the transmitter. The receiver produces an output signal when the directional output signal from the transmitter is detected that is received by a microcontroller that is incorporated into a switch controller. The microcontroller produces an output that switches the electrical appliance to which the switch controller is connected on and/or off. A coordinator is provided for communicating functional information to and from the switch controller(s) of a plurality of electrical appliances for increased flexibility of operation and control. Although not limited to this use, the system and method of the present invention are particularly adapted for controlling individual light fixtures, even though several fixtures are wired into a single circuit, allowing the individual fixtures to be switched on and/or off as needed and, in the case of light fixtures with multiple lamps, the dimming of the fixture by switching individual lamps in the fixture off.

This application is a continuation-in-part of our co-pending International Application No. PCT/US2008/003845, TARGETED SWITCHING OF ELECTRICAL APPLIANCES AND METHOD, filed Mar. 24, 2008, the disclosure of which is hereby incorporated into this application in its entirety by this specific reference thereto.

The present invention relates to a method and system for switching electrical appliances such as light fixtures, and/or individual lamps or groups of lamps, in a light fixture or multiple fixtures, on and/or off. In more detail, the present invention relates to a method and system that enables the user to switch an individual electrical appliance on and/or off from a remote location using a targeted, wireless directional transmitter. Although not limited to this use, the targeted on/off switching system and method of the present invention are particularly useful for switching and/or dimming individual light fixtures, particularly high bay lighting fixtures in commercial applications, that are wired into the same circuit with other like fixtures by turning one or more of the lamps in an individual fixture on and/or off as needed for safe and energy efficient lighting of building interiors and/or exterior spaces even in installations in which the on/off switch for the fixture is not located at the entrance to a building, room, or other location that needs to be lighted, and without the need to re-wire the fixture or the circuit in which the fixture is wired and without the need to string communication/control cables from a control panel or computer to the light fixtures.

A substantial portion of electrical consumption is utilized for lighting. In the face of increasing energy costs, it is therefore important for retail, institutional, industrial, and warehousing operators, and the operators of other commercial and public installations, to minimize the use of electricity for lighting. This need has been partially addressed with techniques such as daylight harvesting and more efficient lighting systems, for instance, by replacing metal halide lights with fluorescents and by the relatively recent introduction of so-called electronic “instant on” and “programmed start” ballasts for fluorescent fixtures and dimmable ballasts for fluorescent and metal halide fixtures. By using instant on and programmed start ballasts for fluorescent fixtures and wiring fixtures into groups that are switched independently of other groups of fixtures as needed for operations in the commercial or public installation, substantial reductions in energy consumption have been achieved. Even so, there is room for improvement in energy cost savings, and there are many installations still using metal halide lights and in which the cost of replacing the lights with fluorescent lighting and/or re-wiring is substantial enough that the operators have not retrofit the installation. Further, electric rates for some commercial installations are calculated on the basis of peak power load, so there is a need to reduce the component of electrical power cost that is based on peak power consumption. This latter need has, so far as is known, not been addressed effectively by so-called point of use strategies for decreasing lighting power consumption and/or peak power consumption.

Remote on/off switching systems are available for switching a ceiling fan and/or light on or off in a room or building. So far as is known, however, the only such systems capable of distinguishing between multiple electrical appliances in a room or building are characterized by their operational limitations, complication, and/or their installation cost. Such systems are available from, for instance, Sensor Switch, Inc. (Wallingford, Conn. and Port Perry, Ontario, www.sensorswitch.com), which markets a so-called “Hospital Bed Light Controller” that is retrofit to existing “pull chain” controlled hospital bed wall lights and operated by an infrared (IR) receiver/controller and an IR transmitter with a range of 8-10 feet. The advertising for the Hospital Bed Light Controller claims that a nurse with one remote can control all the wall lights on the ward or floor of the hospital. Though useful for use in a small room, the range limitations of this system do not allow for effective use unless the operator is close to the wall lights.

U.S. Patent Publication No. US200510025480 describes a laser-activated photoresistor for on/off switching, but a photoresistor is too slow acting for many applications and merely switches on/off with no operating flexibility. Further, the laser-activated photoresistor is susceptible to ambient light such that switching can occur as a result of, for instance, a flashing light or even incident sunlight. The slow response of the photoresistor severely limits the useful range of the remote for this system due to incremental laser movements resulting from shaking or natural movements in hand held operations. U.S. Pat. No. 6,252,358 (and many other systems) use radio frequency (RF) control to switch fixtures, but such systems are complicated and therefore not well suited for use in commercial installations in which many fixtures must be controlled. Further, RF systems are not targeted to specific fixtures and/or individual lamps or groups of lamps such that in the absence of encoding of the RF signal (and the resulting complexity of operation), fixtures are switched that are not intended to be switched.

U.S. Pat. Nos. 4,897,883 and 6,828,733 disclose handheld IR transmitters said to be capable of switching individual fixtures. However, the systems described in those patents utilize encoded IR signals and pre-programmed, separately addressable IR receivers mounted to the fixtures controlled from the handheld transmitter to switch individual fixtures, requiring increased operational complexity and cost of installation, especially in installations with many fixtures.

So-called DALI (digital addressable lighting interface) systems are available (for instance, from Specialized Lighting Solutions, Beaverton, Oreg., and Complete Technology Integrations Pty Ltd, North Ryde, NSW (and other cities in Australia)). Although impressive in their capabilities and operational flexibility, such systems are expensive to purchase and install, may require specialized programming or re-programming when changes are needed in a particular installation, and are operationally complex.

It is, therefore, an object of the present invention to provide an on/off switching and/or step dimming system for a commercial installation, public space, governmental building, sports and/or entertainment facility, or other lighted area that enables individual light fixtures, groups of light fixtures, and/or the lamps or groups of lamps in individual or multiple light fixture(s), to be turned on and/or off as needed using a hand-held remote, a coordinator that may, for instance, be wall-mounted, and/or a system administrator that may be, for instance, PC-based, even when several such fixtures are wired into the same electrical circuit. Although not limited to this application, the on/off switching system of the present invention is particularly useful for switching so-called high bay lighting in industrial buildings. Those skilled in the art who have the benefit of this disclosure will recognize that such lighting is also utilized in retail buildings and in warehouses, and that the present invention may also be used for switching light fixtures in buildings such as theaters, auditoriums, schools, gymnasiums, and any building in which the cost of energy for lighting is high enough that cost savings are desirable. The on/off switching system of the present invention is also utilized for switching and/or step dimming outdoor canopy lights and other outdoor lighting fixtures in, for instance, athletic fields, parking lots and garages, storage lots, docks, freight terminals, railroad switching yards, construction sites, and anywhere else where lights are needed for outdoor operations.

Another object of the present invention is to provide a switching and/or dimming system for a commercial building or other indoor or outdoor installation that utilizes the existing wiring and light fixtures of the installation so as to avoid the cost of re-wiring and/or replacing the light fixtures while still enabling individual fixtures, or individual lamps in fixtures having multiple lamps, to be turned on and/or off as needed to provide the illumination needed for the safety and security of operations in the space illuminated by individual fixture(s). Depending upon the cost of the electricity, the amount of illumination needed, and the level of control, installation of the switching system of the present invention can, on information and belief, achieve energy savings that could re-pay the cost of installing the switching system of the present invention in as little as a year.

Another object of the present invention is to provide a method of switching individual light fixtures, and/or the lamps or groups of lamps in a fixture with multiple lamps, on and/or off without switching other light fixtures that are wired into the same electrical circuit using a narrow, focused output signal from a transmitter that is aimed at a sensor located on the specific light fixture to be switched on and/or off.

Another object of the present invention is to provide a system and method that allows lights or other electrical appliances to be switched on in sequence, or one light fixture or appliance at a time, even when the lights or appliances are wired into a single electrical circuit, for the purpose of reducing the peak power that would otherwise be required to turn on all the lights or appliances wired into that circuit.

Another object of the present invention is to provide on/off switching and/or step dimming for the light fixtures in a commercial installation that is adaptable for different levels of control of the light fixtures, for instance, at one level by employees or other personnel at the installation for use during shift operations using a hand-held remote and/or a centralized coordinator that is, for instance, wall-mounted, at a second level using a centralized coordinator, and at a third level from a system administrator by supervisory or on-premises security personnel for instance, after employee shift operations have ended.

Yet another object of the present invention is to provide an on/off switching and/or step dimming system that can operate across open spaces where it is not practical, and sometimes where it is not even possible, to install wiring for connecting an electrical appliance to a control system of the types that are presently available.

Another object of the present invention is to provide on/off switching and/or step dimming for light fixtures and/or other electrical appliances in a commercial installation that is adaptable for different levels of control and that is comprised of multiple control components including a hand-held, transportable remote for targeted switching of fixtures and/or appliances, a coordinator for managing the system in accordance with operator-selectable operations rules, and an optional system administrator for receiving operational data, changing operations rules, and managing other tasks and capabilities of control components. The coordinator receives (via hard-wired or wireless network) operational information from fixtures and/or appliances to manage the system in accordance with user-specific operations rules. The coordinator employs a real time clock (RTC) that enables time-related functions and features. For example, the coordinator may turn certain groups of lights on at 6:15 am Monday morning in anticipation of employee arrivals and turn non-security lights off at 10:00 pm when employees are not present. If a motion sensing equipped fixture reports a change of status during non-operations hours, the coordinator may alert the facility administrator, which can function as a compliment to existing alarm systems. The coordinator is preferably provided with a battery back up so that it does not become disoriented during a power failure or planned maintenance.

Another object of the present invention is to provide on/off switching and/or dimming system for lights where the lights can be controlled from various and distant locations where it is advantageous for operator not to reveal his/her position such as in a hostile environment and/or in military, security, or surveillance operations.

Another object of the present invention is to provide a switching system including a remote transmitter that produces a low divergence beam, enabling a specific appliance to be switched without switching other appliance(s) even when closely spaced.

Similarly, it is an object of the present invention to provide an on/off switching and/or dimming system that enables the control of appliances even through walls, around corners, and around natural or man-made barriers.

Another object of the present invention is to provide a switching system for the light fixtures or other appliances in a commercial installation that works well and provides operational flexibility with programmable lighting systems of the type used, for instance, for daylight harvesting, with timers, and with photo-sensing and motion-sensing fixtures, while still enabling operation by untrained personnel who can control the fixtures, the individual lamps of a fixture with multiple lamps, and/or groups of fixtures, without operating a central control console, switch pad, or computer.

Another object of the present invention to provide a switching system for the light fixtures or other electrical appliances in a commercial installation that works well and provides operational flexibility that is controlled at multiple levels, for instance, from a control panel/coordinator or PC-based system administrator, while still enabling operation by untrained personnel who can control the fixtures, the individual lamps of a fixture with multiple lamps, and/or groups of fixtures.

Another object of the present invention is to provide a switching system that is adapted for controlling the fixtures, the individual lamps of a fixture with multiple lamps, and/or groups of fixtures, with a handheld remote, central control coordinator or switch pad, and/or local or remote computer capable of operating the fixtures, or the individual lamps of one or more fixtures, in a pre-programmed operating mode, for instance, in the event of a fire alarm or for switching all lights on quickly in the event of an emergency.

Because the switching system of the present invention is capable of controlling individual lamps in a single fixture, it provides operating efficiencies and flexibility that is not, on information and belief, previously available. For instance, two lamps of a ten-lamp fixture may provide sufficient illumination for a particular installation for 20 hours per day such that all ten lamps are switched on for just four hours per day. Using the switching system of the present invention, the time each of the lamps of the fixture are switched on is monitored and, as two of the ten lamps in the fixture approach a user-selected percentage of their normal operating life, the fixture selects two other lamps to be switched on for 20 hours per day, and so on, such that the time between lamp changes is effectively increased. If the lamps are, for instance, rated at 10,000 hours, rotating the two lamps in the fixture that are switched on for 20 hours per day effectively provides a ten-lamp fixture with a 50,000 hour service life that still provides the light produced by all ten lamps in the fixture for four hours per day. Because the system of the present invention monitors the time the lamps are switched on, the present invention provides the opportunity for preventive maintenance in the sense that all ten lamps can be changed as they approach 10,000 hours of operation. Further, the system of the present invention is capable of providing real-time data on such parameters as current consumption by the fixture and/or by the lamps mounted in the fixture so that the above-described coordinator, having been pre-programmed with the appropriate operations rule(s), can switch lamp(s) in the fixture when a current level is detected that is outside the range of normal operating parameters on the assumption that the particular lamp(s) and/or ballast being switched on may have exceeded the end of its/their service life. It is, therefore, an object of the present invention to provide a method and system for effectively extending the service interval in a multiple-lamp fixture that is sometimes operated with fewer than all the lamps in the fixture switched on.

It is also an object of the present invention to collect operating data from individual light fixtures in real time and to utilize the data collected from the fixtures to maximize and/or optimize the use and operation of the fixtures, thereby providing more efficient and effective lighting, maximizing the life of the lamps in the fixtures, and increasing the length of time between lamp and/or ballast replacement.

Another object of the present invention is to provide a system and method by which each fixture or appliance in an installation employs an accurate current sensor to monitor and report on the individual fixture's/appliance's actual energy consumption. This information is used to validate system performance (as compared to system specifications), allowing operators to accurately document relative advantages in using different ballast/lamp manufacturers. This capability is useful in, for instance, validating compliance with governmental and non-governmental incentives for energy efficiency, as well as providing a useful management tool and is a foundational, or enabling, feature that makes possible may related advantages in operation and application, including:
Temperature Management. The system monitors and controls the temperature of the fixtures/appliances through the use of temperature sensors and selected operations rules. Management of fixture temperatures is essential in achievement of maximum energy efficiency of the lamp/ballast combination. Temperature management of electronic ballasts and controls is also important in extending the useful life and optimum functioning of those components. Temperature management includes the recording and processing of data and specific responses or actions of temperature control, for example, temperature sensors detect an internal electronic module temperature of 32° C. The fixture's controller switches a cooling fan on and the fixture continues operation routine and the coordinator is informed through routine operating data collection. If the reported temp is greater than 50° C. for example, the fan remains on, a temperature alert is issued to the coordinator, and the coordinator implements the user-specific operating rule to determine action. For example, if the fixture's group affiliation is such that it can be dimmed safely, the coordinator may turn off two (of six, for instance) operating lamps to contain fixture operating temperature within pre-established parameters (i.e., temperatures within the specified ballast warranty @60° C.). On information and belief, this system provides several previously unavailable advantages in the operation of the light fixture(s), for instance, controlling operating temperatures to assure maximum system energy efficiency (watts/lumen) and extending the useful life of the system, therefore reducing operating costs and disposal burdens on the environment. The system also enables users to document compliance with the terms of warranty for the components of the system (electronics, lamps, etc).
Lamp Life Optimization. This system also has the distinct advantage of simultaneously optimizing lamp life and extending required service intervals. In accordance with the method of the present invention, fixtures report any change in operation of status to a coordinator. The coordinator also routinely “polls” fixtures to audit, or verify, that operations are properly logged and that energy consumption complies with user-specific parameters. The coordinator records and stores operational data for each set of lamps for each fixture and uses this data to activate certain operations rules. For example, if the user specifies that the sequence of lamp use should be rotated when the first set of lamps reaches 100% of lamp manufacturer's rated life, then the coordinator changes the relay sequence so that this group of lamps moves from first to last in the relay activation sequence. The lamps are still available if full illumination is required of the fixture; however, lamps with longer remaining useful life are activated first, maximizing the useful life of the lamps and extending the maintenance intervals. This documentation of lamp utilization is very useful in determining which lamps to replace and the warranty status on any lamp that fails prematurely.
Lamp/Ballast Failure Response. The system and method of the present invention is also capable of detecting a ballast and/or lamp failure and responding in accordance to user-defined operating rules. During the course of operation, the coordinator compares the operation status of the fixture with its reported energy usage to detect a malfunction in fixture operation. For example, if fixture status indicates two lamp operation and energy usage is out of typical consumption for two lamp operation (as defined by the user), the coordinator identifies a malfunction that is reported to the system administrator so that service can be scheduled and warranty status determined. The advantage of this feature is that the malfunctioning group is replaced automatically and that properly functioning groups will assume the relay sequence of the malfunctioning group. Because the coordinator knows the location and identity of the malfunctioning unit, effort and cost can be saved in trouble shooting and searching for malfunctioning lamps.
Additional Equipment Monitoring. The coordinator of the system of the present invention is capable of processing inputs from additional electrical appliances beyond the light fixtures. Using this feature, other energy consuming appliances become part of the network, reporting their operational data to the coordinator which can then process, report or act upon those inputs. This configuration of the system of the present invention allows wireless or hard-wired communication between the coordinator and a system administrator to monitor and evaluate the energy consumption of a broader group of appliances. This network can also be used to convey data for other purposes such as scheduling.

Another object of the present invention is to optimize lamp performance by monitoring the time the lamps are switched on/off, the temperature of the fixture in which the lamps are mounted, and the current delivered to the lamps/ballast, and using that information to operate the lamps in a way that produces more lumens per unit of energy consumed, extends the life of the lamps, extends the time between lamp and/or ballast replacement, and to plan and perform maintenance on the fixture.

Still another object of the present invention is to provide a system for controlling a light fixture or group of light fixtures that increases the amount of light produced by the lamps in the fixture(s) and decreases the amount of energy consumed by the lamp(s) by utilizing operating data from the fixture(s) and varying such parameters as the number of lamps switched on and/or to switch a ventilating fan mounted on the fixture on and/or off to exhaust heat from the fixture (or to not exhaust heat from the fixture as may be needed to increase temperature in the fixture) to maximize ballast life and to maximize the amount of light produced per watt of electricity consumed by the lamps in the fixture.

Although described herein as being useful for controlling light fixtures, those skilled in the art will recognize from this disclosure that the present invention is also intended for switching other types of electrically-activated devices, for instance, electrical motors, sensors, and components of security systems. For that reason, the term “electrical appliance” is used herein for the purpose of describing other devices that can be switched on and/or off with the system and method of the present invention and all references to lights and light fixtures herein should be construed as references to electrical appliances. Consequently, in a broader sense, it is an object of the present invention to provide a switching system and method for switching any electrically-activated device as needed for energy cost savings and other purposes as described herein.

This listing of several of the objects of the present invention is intended to be illustrative, and is not intended to be a complete listing of all the objects of the invention, nor is it intended to restrict the scope of the invention(s) described and/or claimed herein. Other objects, and many advantages of the present invention, will be made clear to those skilled in the art in the detailed description of the preferred embodiment(s) of the invention and the drawings appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of a targeted on/off switching system and method constructed and/or performed in accordance with the teachings of the present invention.

The present invention addresses the above-described needs by providing a system for switching an electrical appliance comprising a portable transmitter for selectively producing a directional output signal and a receiver having a sensor for producing an output when the directional output signal from the transmitter is detected by the sensor. A switch controller comprising a microcontroller and a connector adapted for connecting to an electrical appliance receives the output from the receiver and outputs a signal to the electrical appliance through the connector for switching the electrical appliance.

Also provided is a system for dimming a light fixture having multiple lamps by switching one or more of the lamps in the fixture on and/or off comprising a portable transmitter for producing a directional output signal and a receiver having a sensor for producing an output when the signal from the transmitter is detected by the sensor. A switch controller comprising a microcontroller and a connector adapted for connecting to individual lamps in a light fixture receives the output from the receiver and outputs a signal to selected lamps in the fixture through the connector for switching the lamps.

In another aspect, the present invention provides a method of switching an electrical appliance comprising the steps of activating a transmitter to produce a directional output signal and aiming the transmitter at a sensor located on an electrical appliance. A signal is output from the sensor when the sensor detects the output signal from the transmitter and a signal is output from a microcontroller upon receipt of the output signal from the sensor by the microcontroller. Upon receipt of the output signal from the microcontroller, the electrical appliance is switched.

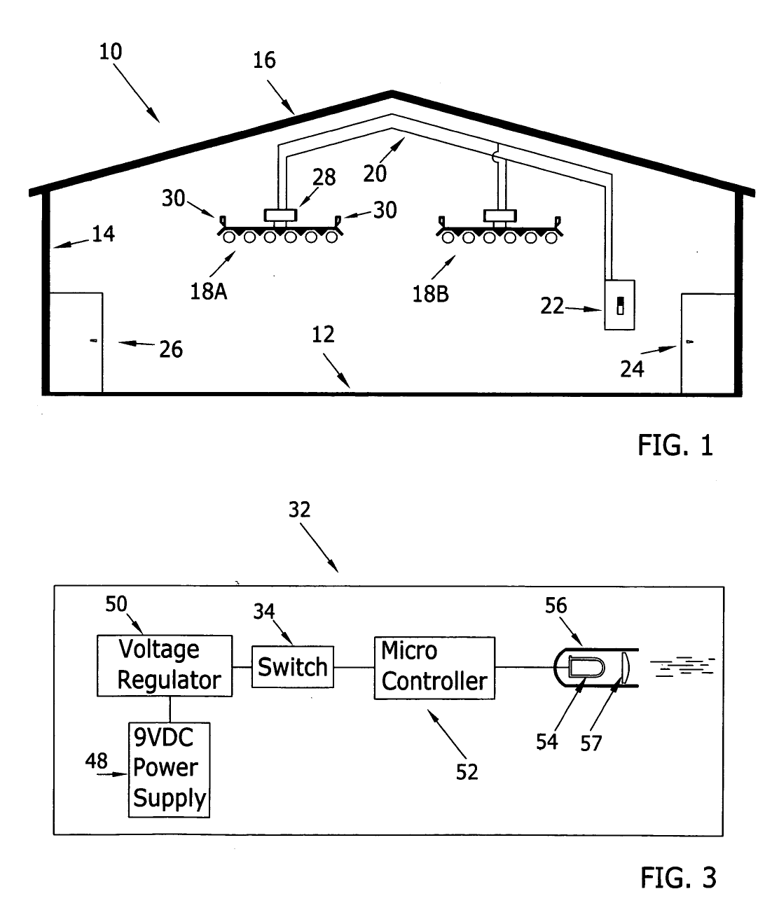

Referring now to the figures, FIG. 1 is a diagrammatic view of an open-frame building with high bay lighting fixtures installed and wired in a manner commonly utilized in which the targeted switching system of the present invention may be installed.

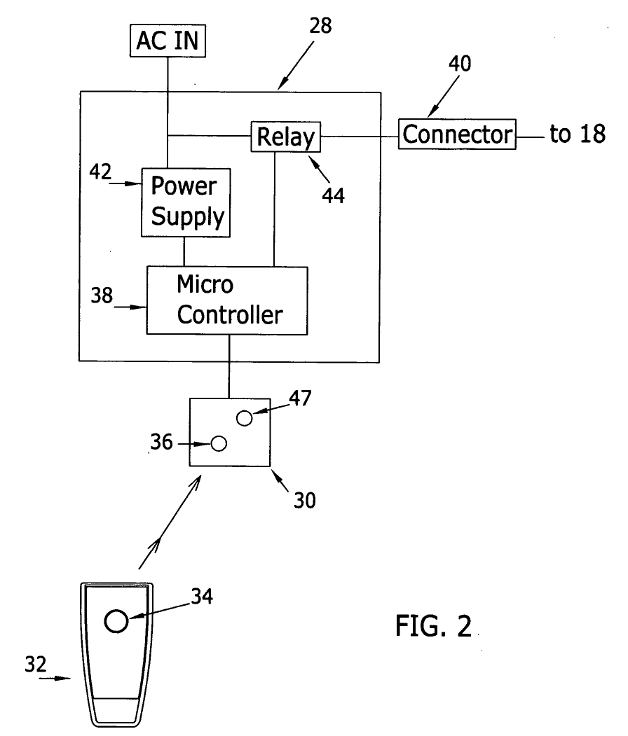

FIG. 2 is a schematic diagram of a first embodiment of a switching system in accordance with the present invention for use in a building as shown in FIG. 1.

FIG. 3 is a schematic diagram of the circuitry comprising a first embodiment of the remote transmitter of the targeted switching system of FIG. 2.

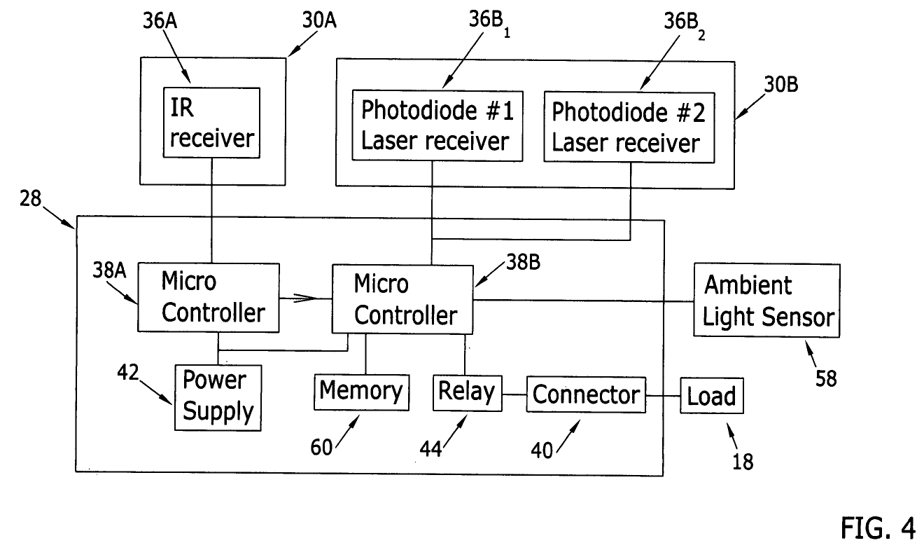

FIG. 4 is a diagrammatic view of a second embodiment of the receiver of the switching system of FIG. 2.

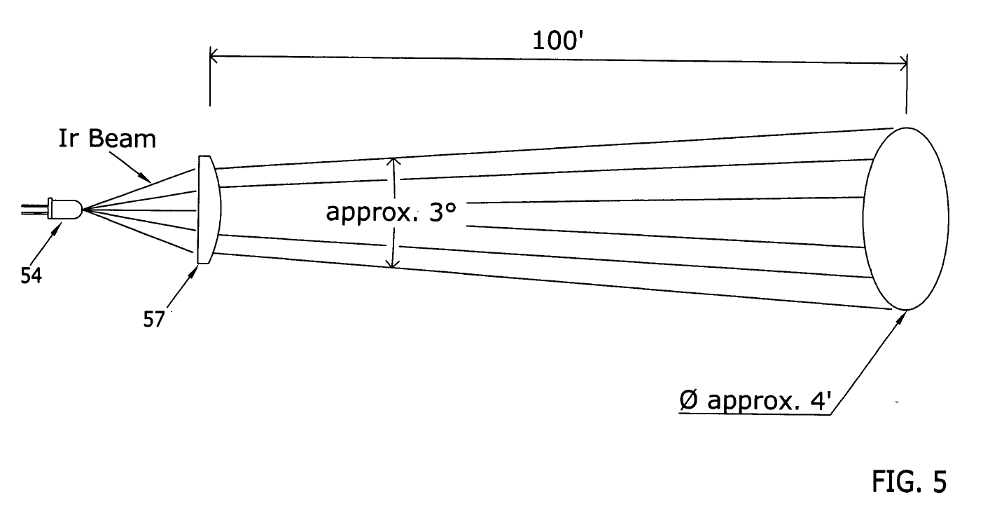

FIG. 5 is a diagrammatic view of the low divergence output signal of the remote transmitter of the targeted switching system of FIG. 2.

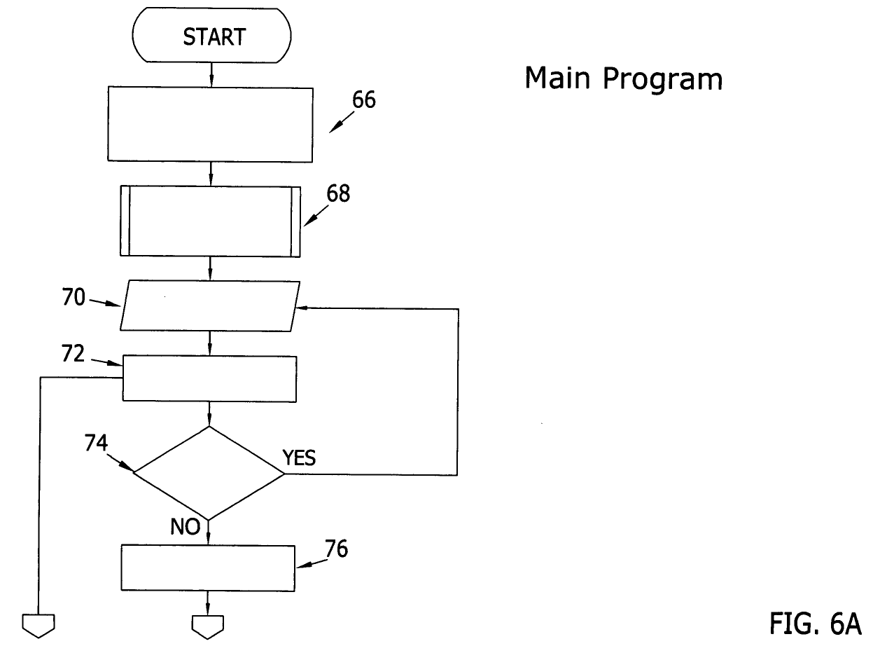

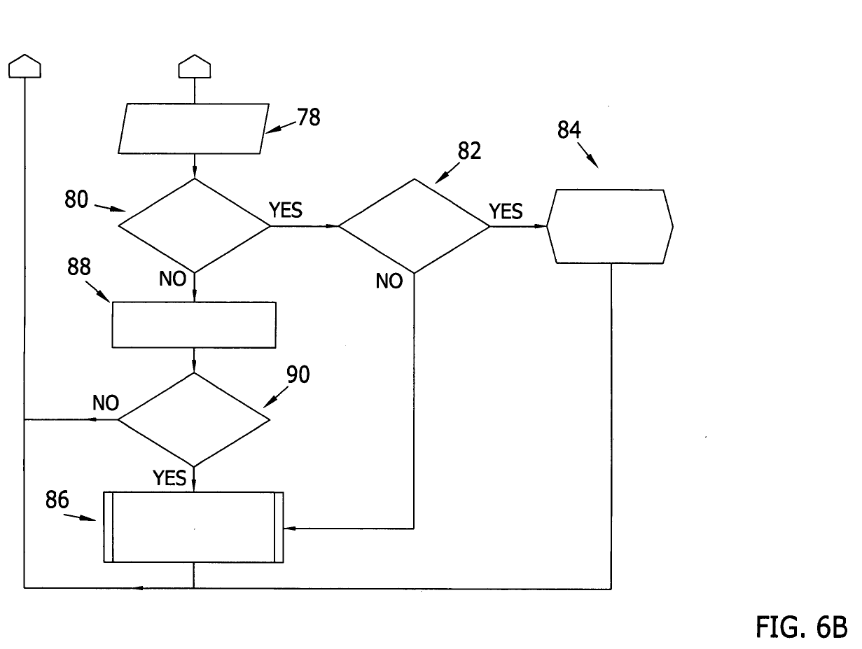

FIG. 6 is a logic diagram showing a first embodiment of the control software for implementing the method of the present invention.

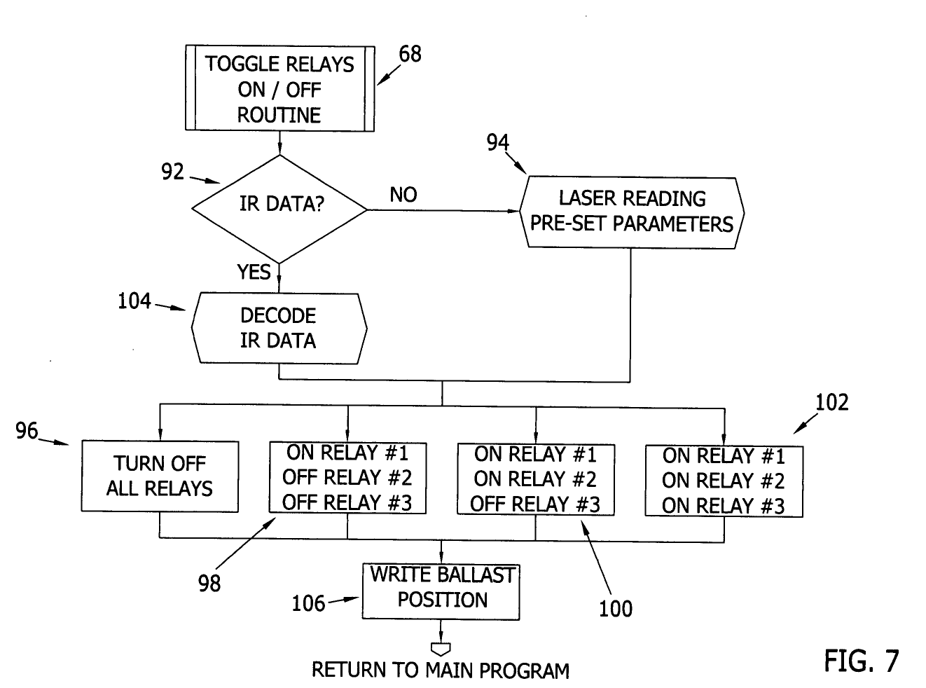

FIG. 7 is a logic diagram of a first embodiment of a program for controlling the targeted switching system of FIG. 2 that includes the capability of switching individual lamps in a fixture including multiple lamps for the purpose of dimming the light produced by the fixture.

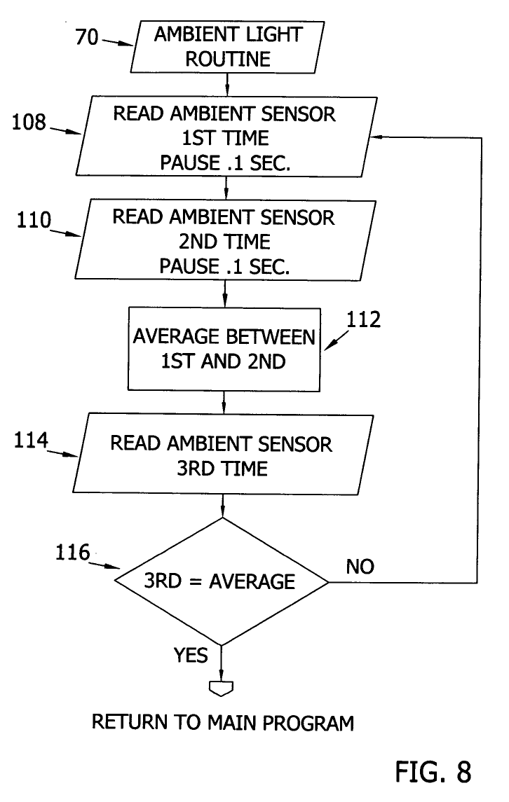

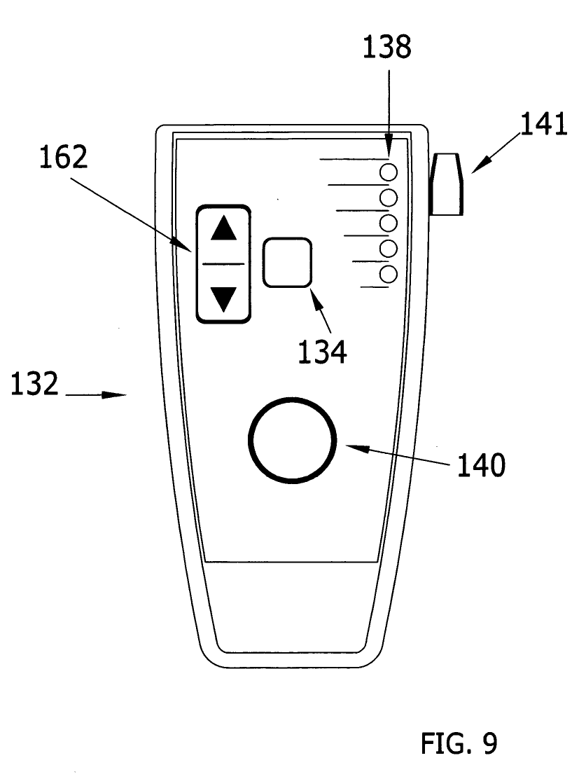

FIG. 8 is a logic diagram of a first embodiment of a program for controlling the targeted switching system of FIG. 2 including the ambient light sensor shown in FIG. 4.

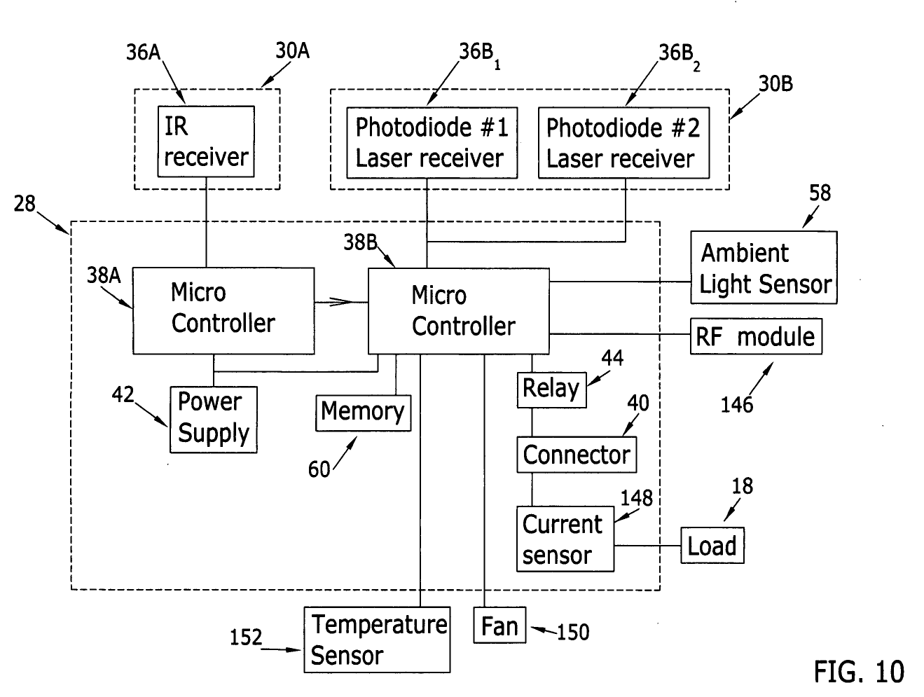

FIG. 9 is a top plan view of a second embodiment of a remote transmitter for use with the targeted switching system of FIG. 2 that is adapted for dimming a fixture by switching individual lamps in a fixture including multiple lamps on and/or off.

FIG. 10 is a schematic diagram of a second embodiment of a switching system in accordance with the present invention for use in a building as shown in FIG. 1.

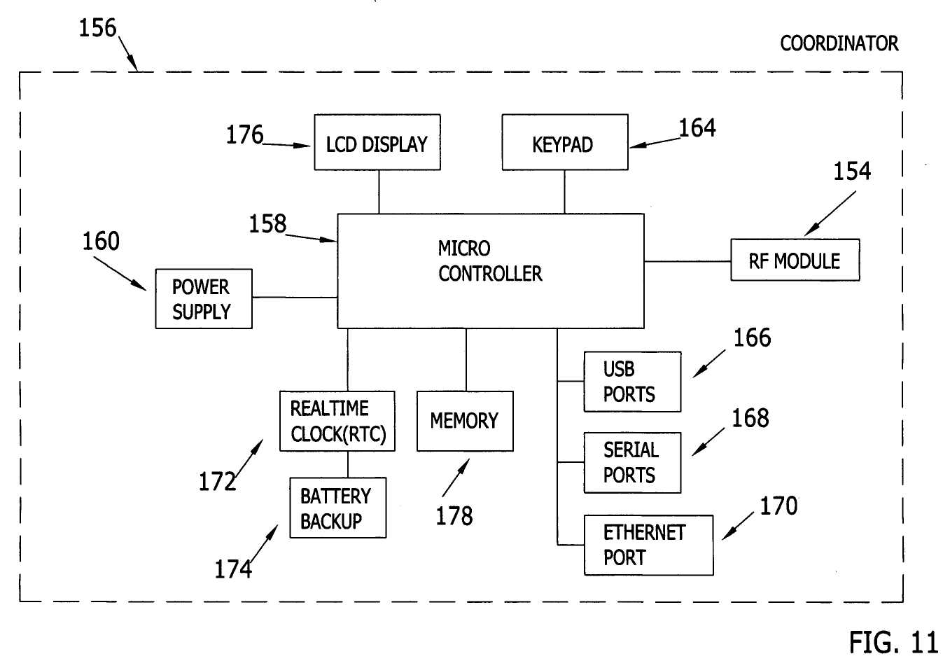

FIG. 11 is a schematic diagram of a first embodiment of an embodiment of a coordinator constructed in accordance with the teachings of the present invention for use in conjunction with the switching system shown in FIG. 10.

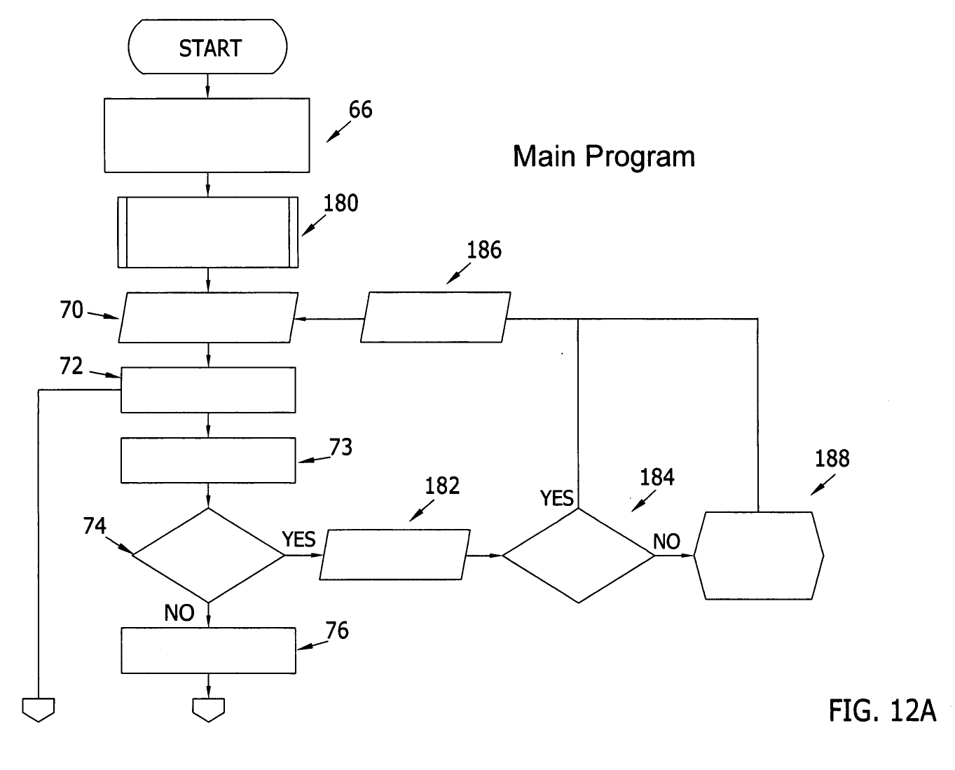

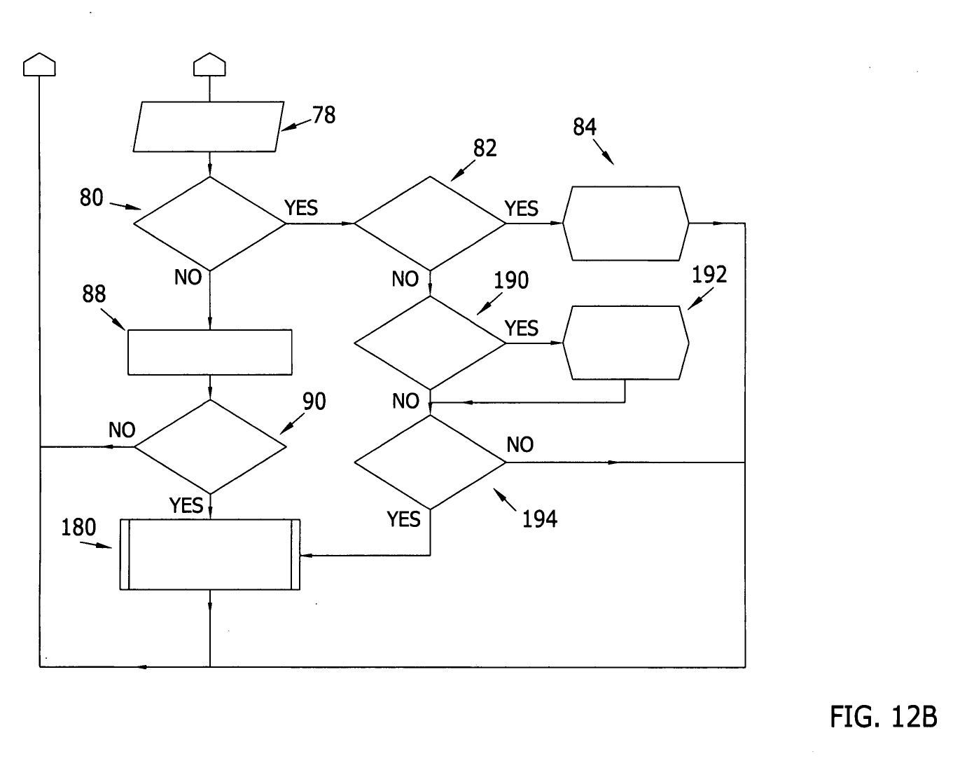

FIG. 12 is a logic diagram of a first embodiment of a program for controlling the switching system shown in FIG. 10.

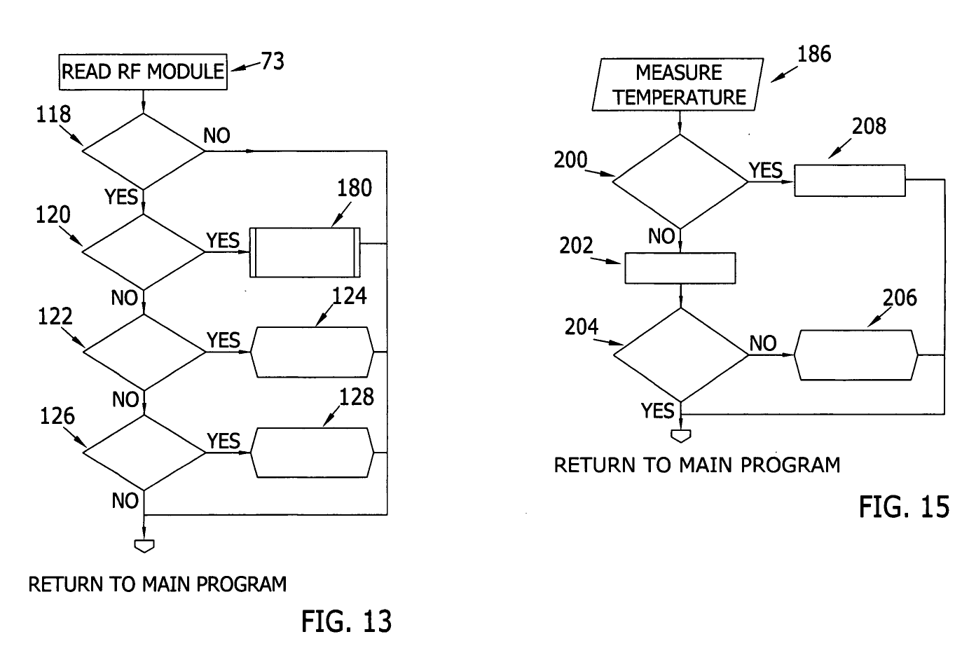

FIG. 13 is a logic diagram of a subroutine for collecting functional information received by an RF module mounted on a light fixture having the switching system shown in FIG. 10 mounted thereto.

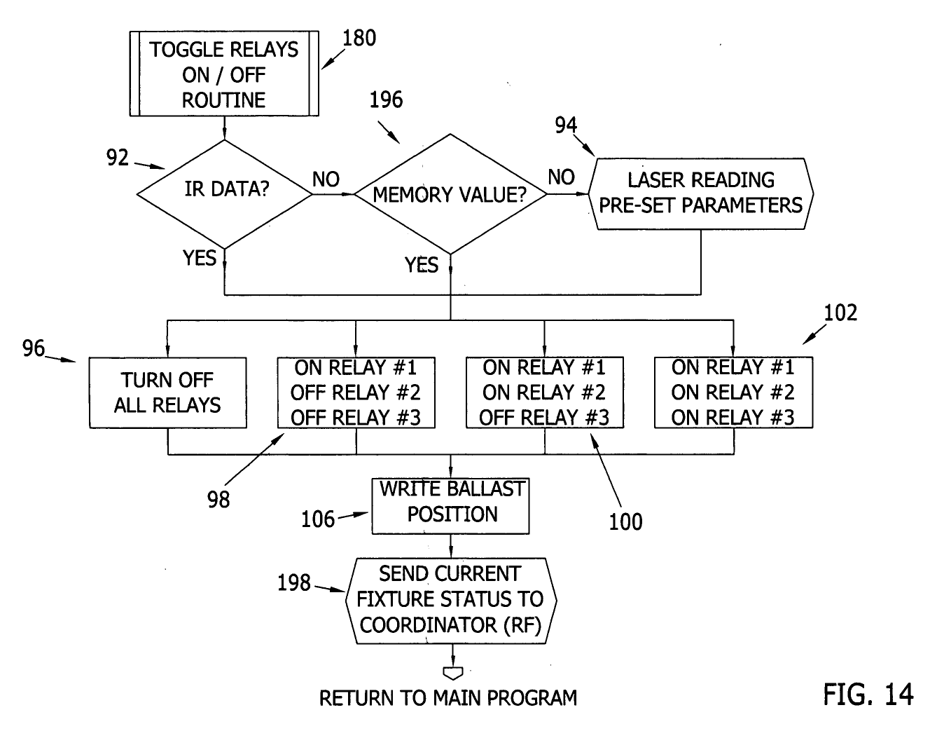

FIG. 14 is a logic diagram of a second embodiment of a program for controlling a light fixture having the switching system shown in FIG. 10 mounted thereto that includes the capability of switching individual lamps in a fixture including multiple lamps for the purpose of step dimming the light produced by the fixture.

FIG. 15 is a logic diagram of a program for sampling and transmitting temperature data to a coordinator in accordance with the method of the present invention.

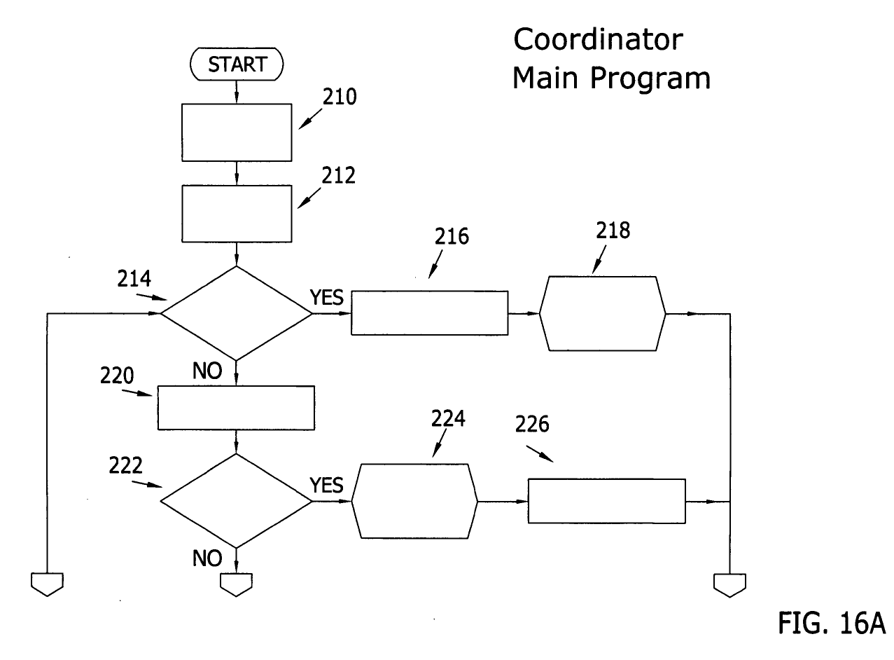

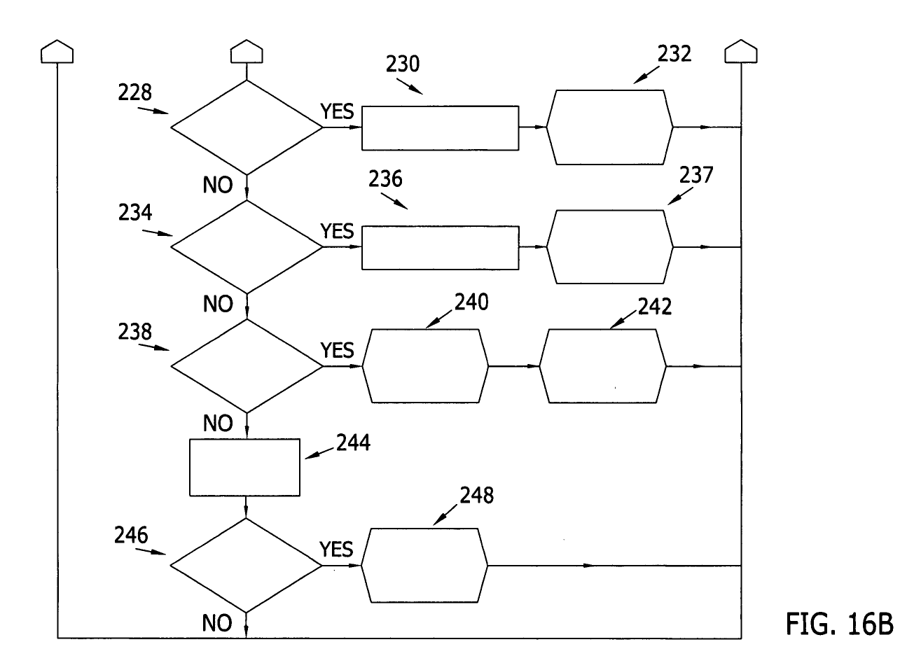

FIG. 16 is a logic diagram of a program for controlling the coordinator shown in FIG. 11.

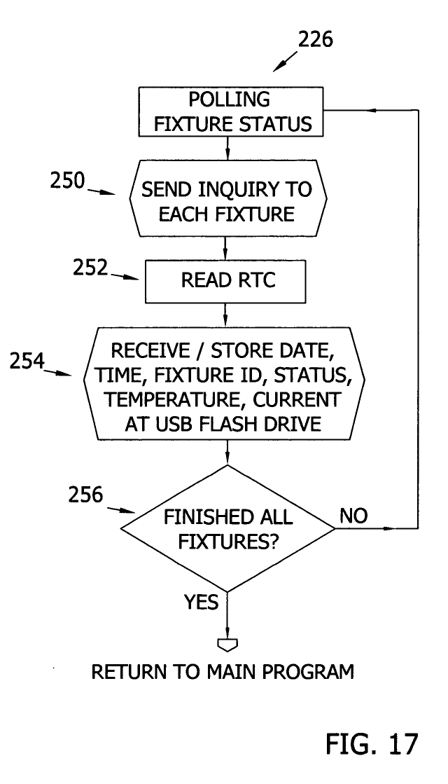

FIG. 17 is a logic diagram of a subroutine for polling the switch controllers of multiple fixtures for the purpose of collecting functional information in accordance with the method of the present invention.

In more detail, a common type of commercial building is the open-frame building 10 shown in diagrammatic view in FIG. 1. Such buildings are built on a concrete slab or pad 12 with metal walls 14 and a roof 16 supported by beams or girders (shown as part of the roof in FIG. 1 for purposes of convenience). In a typical open frame building, two, four, six, or more lamp fluorescent light fixtures 18 are suspended from the beams or girders supporting roof 16 at spaced intervals and two, four, six, eight, or more such fixtures 18 (two such fixtures 18 being visible in the sectional view shown in FIG. 1) are wired into a circuit 20 that is switched from a wall-mounted on/off switch 22 located near a door or entrance 24 into the room or building. Although the construction and high bay lighting shown in FIG. 1 is widely utilized because of its reliability, flexibility, and utility, problems arise when, for instance, one enters a dark building from the door or entrance 26 on the wall opposite the door/entrance 24 where the wall-mounted switch 22 is located. Of course the circuit 20 can be wired with multiple switches to solve the problem of lack of light when entering through door 26, but additional switches increase installation costs.

Another problem arises when operations are conducted under only one or two of the several light fixtures 18 controlled from a single switch 22. Although the light from other fixtures in circuit 20 is not needed for operations under specific fixtures 18, all the fixtures are powered on because they are all wired into circuit 20. Another problem arises when operations requiring less light than the light output by all the lamps in a fixture 18 are conducted under light fixtures 18 controlled from the same switch 22. Although the light from the other fixtures in circuit 20 may not be needed for operations under specific fixtures, or less light may be needed than the light produced by the lamps in the fixture under which operations are conducted, all the lamps in all the fixtures 18 are powered on because all the fixtures 18 are wired into circuit 20. As a result, energy consumption and peak load are increased as compared to operating just one or two specific fixtures 18A and 18B in circuit 20 or fewer than all the lamps mounted in fixtures 18A and 18B.

To address these (and other) problems, circuit 20 is provided with the components (shown out of scale for purposes of illustration) of a point of use switching system constructed in accordance with the present invention. Specifically, each of light fixtures 18 is provided with a switch controller 28 having one or more receivers 30 operably connected thereto. In the embodiment shown in FIG. 1, receivers 30 are mounted to opposite sides of light fixtures 18 to receive a signal from a portable remote transmitter 32 (not shown in FIG. 1; see FIGS. 2 and 3) that is, for instance, carried by a person to turn an individual fixture 18A or 18B on or off from either of doors 24 or 26. As can be seen in FIG. 1, and as set forth below, switch controllers 28 function to turn individual fixtures 18 on or off even when multiple fixtures are wired into the same circuit 20.

A first embodiment of the switching system of the present invention is shown in FIG. 2. The system is comprised of switch controller 28, one or more receivers 30 operably connected to switch controller 28, and portable transmitter 32. Transmitter 32 includes an infrared (IR), laser, or other light-emitting source that is selectively activated by pushing on/off button 34. The particular transmitter 32 shown in FIG. 2 utilizes IR output signals and the resulting beam is focused (as described below) to a low divergence beam, achieving a directionality that enables transmitter 32 to be aimed at the receiver 30 on an individual light fixture 18 to be switched when button 34 is pushed. By aiming the transmitter 32 at an individual light fixture 18, the directional output signal produced by transmitter 32 is detected only by the sensor 36 of controller 28 mounted to the targeted fixture 18. The sensor 36 of receiver 30 mounted to the targeted light fixture 18 produces an output to the microcontroller 38 of switch controller 28. Microcontroller 38 is configured so that when an output is detected from sensor 36 of receiver 30, a signal is output to light fixture 18 through a connector 40 and mechanical or solid state relay, or other appropriate switching device, 44 to switch the light fixture. Switch controller 28 additionally comprises a power supply 42 as known to those skilled in the art.

In one embodiment, receiver 30 is provided as a self-contained unit that plugs into an appropriate socket (not shown) that is integral with switch controller 28. In this embodiment, switch controller 28 is configured so that whenever the receiver 30 is removed from the socket, the relay(s) 44 close the circuit so that the fixture will switch on whenever the circuit is energized. This function is useful to allow the fixture 18 to revert to manual operation when remote control function is not operating properly or if the user opts to disable the remote function for maintenance or other reason.

The sensor 36 of receiver 30 is preferably comprised of a photodiode, or even more preferably an array of photodiodes, because of their quick response. Because the receiver is mounted to a light fixture 18 that must be switched on to provide light as desired, the light fixture may be located in partial, or even total, darkness such that it may be difficult to see a specific fixture to be turned on with portable transmitter 32. Consequently, receiver 30 may also be provided with an LED target 47 located in close proximity to the sensor 36 so that a directional signal output from transmitter 32 that is aimed at the target 47 is detected by sensor 36. Of course those familiar with lighting design will recognize that a sensor that detects an incident laser beam may produce an output signal when light is detected from the lighting fixture to which it is mounted, visible light from a passing vehicle or other source (such as the strobe light or headlights of a passing forklift truck), or natural light (none of which are concerns for IR sensors). Consequently, if sensor 36 detects a laser beam, receiver 30 is either mounted above the light fixture (see FIG. 1) or, if receiver 30 is mounted in or under fixture 18, shielded from the light produced by fixture 18 (or other light sources) so that the sensor 36 does not produce an output signal when the light fixture itself is switched on. Alternatively, the microcontroller 38 is provided with a sensor and programming for adjusting sensitivity (see FIG. 4). Of course it will be recognized by those skilled in the art who have the benefit of this disclosure that if the sensor 36 is a detector for incident laser beams, and if the switch controller 28 is mounted to an electrical appliance that is located outdoors, providing microcontroller 38 with a sensor and programming for adjusting sensitivity provides a way to avoid switching the electrical appliance on/off in response to changes in ambient lighting, and coincidentally, provides a system that is extremely sensitive to an incident laser beam in low ambient light conditions. Operation of the embodiment shown in FIG. 4, which includes an ambient light sensor 58, is described below. Of course if the receiver 30 including sensor 36 is mounted above a directional light fixture, the receiver 30 is located in at least partial darkness even when the lamp(s) in the fixture is/are switched on so that the target 47 may be an important component for operation and use of the system and method of the present invention even when the lamp(s) is/are switched on.

Referring again to FIG. 3, in one embodiment, transmitter 32 is comprised of a power supply in the form of battery 48 and voltage regulator 50 for powering a microcontroller 52 when switch 34 is closed at the voltage requirements for the particular microcontroller 52. The output from microcontroller 52 to LED 54 is utilized to pulse LED 54 on and off so as to encode the IR output from LED 54. The IR beam produced by LED 54 is preferably a low divergence beam produced by narrowing the beam with an optical or mechanical focusing device. Of course the spread of the IR beam is a function of the distance between LED 54 and the target 47 of a particular fixture 18, and so the degree of divergence of the IR beam for optimal control of individual fixtures is likewise a function of distance. In one embodiment, for instance, the LED 54 in transmitter 32 produces an IR beam with sufficient intensity that it has a useful range of about 100 feet. It has been found that, for such a transmitter, it is useful to restrict, or narrow, the IR beam produced by LED 54 so that the size of the beam is approximately 3-5 feet at a distance of 100 feet as shown schematically in FIG. 5. To obtain a beam of that size at that range, it has been found that limiting the divergence of the IR beam to an angle of approximately 3° (or approximately 1.5° from the central axis of the beam) facilitates the targeting of specific receivers 30 mounted to specific electrical appliances, but the present invention is not considered to be restricted to an IR output signal of that angle.

In one embodiment shown in FIG. 3, the narrowing, or restricting, of the IR beam is accomplished by mounting LED 54 in a recess 56 with a relatively narrow opening to decrease the divergence of the output signal from transmitter 32. Those skilled in the art who have the benefit of this disclosure will recognize that limiting the divergence of the directional output signal from transmitter 32 can also be accomplished with a lens, lens set, mirror, mirror and lens, coated mirror, lens, or lens set, or a mechanical restrictor so long as divergence of the output signal is limited to the point that it can be targeted to a specific receiver 30 on a light fixture 18 that is intended to be switched without switching an adjacent light fixture. One way to focus the beam produced by LED 54 so that divergence of the IR beam is limited in accordance with the present invention, that has the benefit of increasing the operational range of the IR beam, is shown schematically in FIG. 5, showing a plano convex lens 57 that changes the IR beam produced by LED 54 from a cone-shaped beam to a substantially parallel beam. Although shown schematically in FIG. 5, those skilled in the art will recognize from this disclosure that lens 57 is spaced a fixed distance from LED 54 and fixed in place in a hood or other frame that surrounds LED 54 in transmitter 32 in a manner known in the art. Experimentation indicates that a transmitter 32 that limits divergence of the output signal with the structure shown in FIG. 5 is capable of switching individual fixtures at distances of over 300 feet, however, some of the ability of the present invention to target individual fixtures may be lost at such distances because of the divergence of the beam. Although the invention is not restricted to a beam diameter of approximately 3-5 feet, that beam diameter has been found optimal for targeting individual fixtures such that, if operating ranges of 300 feet or greater are contemplated in a particular installation, transmitter 32 is provided with a lens or lens set that limits divergence of the IR beam so that the diameter of the beam is approximately 3-5 feet at that particular operational distance.

In an alternative embodiment (not shown), the IR beam is restricted by sliding LED 54 in and out of a tubular restrictor in which LED 54 is set (or by sliding the tube in and/or out relative to LED 54), narrowing the beam for targeting a specific fixture to be switched or spreading the beam for switching multiple or widely-spaced fixtures. In another alternative embodiment, the shape of the IR beam is changed by sliding a lens or shaped restrictor (not shown) over the LED 54 to spread the beam so that, instead of a cone-shaped beam with a cross-sectional shape that approximates a circle, the cross-sectional shape of the beam is elliptical. By restricting the beam in this manner, the directional transmitter 32 can be used to quickly switch an appliance on (or off) by “swiping” the beam across the fixture so that the IR beam falls upon the target sensor 36. Because the structure described herein functions in similar fashion to produce similar results, all such structure is referred to herein as “means for limiting the divergence of the output signal” of transmitter 32. Of course if transmitter 32 outputs a laser beam, the beam generally need not be restricted or narrowed at all.

Referring now to FIG. 4, a second embodiment of a switch controller for use in connection with the targeted switching system of the present invention is shown in schematic form. In this second embodiment, the system comprises detectors 36A and 36B that produce an output signal upon detection of either or both of an infrared or laser beam produced by a transmitter (not shown in FIG. 4) such as the transmitter 32 shown in FIG. 2. Detector 36A produces an output signal to a first microcontroller 38A upon detection of an encoded incident infrared beam and the output signal from detector 36B to second microcontroller 38B results from detection of an incident laser beam. Because a laser beam is so focused, the detector 36B is preferably comprised of an array of sensors 36B₁, 36B₂, and so on, each sensor 36B₁, 36B₂ producing an output to microcontroller 38B, for ease of detection of an incident laser beam, especially when a transmitter such as transmitter 32 is aimed at detector 36B from a long distance away. Microcontrollers 38A and 38B are connected to each other, with microcontroller 38B receiving an output from microcontroller 38A depending upon whether an infrared beam has been detected by detector 36A, microcontroller 38B functioning to switch an electrical appliance in the same manner as described above in connection with FIG. 2. In the embodiment shown in FIG. 4, the system also includes the ambient light sensor 58 described above for producing an output to microcontroller 38B for adjusting the sensitivity of the detectors 36B and is provided with EEPROM or other non-volatile memory 60 to which microcontroller 38B writes whenever a change in operating state occurs in the event of a loss of power, microcontroller 38B being programmed to check the non-volatile memory when it is powered up so as to return to the last operating state upon restoration of electrical power. If microcontroller 38B is programmed to return to the last operating state when power is restored, it may also be useful to delay the switching of the electrical appliance connected to relay 42 for the purpose of reducing peak power demand as described above. Those skilled in the art will recognize that a back-up battery can be provided for maintaining current operating state in the event of a loss of power rather than non-volatile memory.

The method and system of the present invention also contemplate a remote transmitter provided with a switch for selectively encoding the directional signal for changing operating functions of switch controller 28. In this embodiment, the switch is provided with settings for producing multiple encoded outputs, for instance, a main on/off signal, an over-ride signal as described below, a signal for changing filtering parameters of switch controller 28 as described below, a signal for changing the sensitivity of switch controller 28 as described above in connection with ambient light sensor 58, and a setting for activating a diagnostics and/or re-set routine programmed into microcontroller 38. The signal for selecting the filtering parameters of switch controller 28 from two or more sets of filters programmed into microcontroller 38 is used to filter out spurious signals such as might be produced by safety strobe lights. The “over-ride” signal is utilized to set microcontroller 38 in a mode in which on/off signals output from the remote are ignored either for a selected period of time or until a second over-ride signal is received. This over-ride signal is useful in installations in which, for instance, security and/or safety standards require selected light fixtures to remain switched on at all times, and prevents those selected fixtures from being switched off by the main on/off encoded signal output by the remote transmitter. The ability to re-program the switch controller with the remote provides a safety advantage because the fixture is often positioned high above the floor and is connected in a circuit that may be operating at high voltage.

Referring now to FIG. 6, there is shown a flow chart of a presently preferred embodiment of a program that may be stored in the memory of the microcontroller 38 for implementing a method utilizing the targeted on/off switching system of the present invention. In the particular embodiment shown, the program commences with the step 66 of reading the last operating status of a fixture or appliance (such as the fixture 18 shown in FIG. 1). In the particular embodiment contemplated in FIG. 6, the control software includes software for dimming a light fixture in which multiple lamps are mounted as implemented by the toggle relays on/off routine 68 shown in more detail in FIG. 7 and described below. In the next step, the output from the ambient light subroutine 70, shown in detail in FIG. 8 and described below, is read and counter/timer 72 is checked. If the counter parameter is met as at step 74, the ambient light routine is sampled again and the method cycles through counter/timer 72 until the counter parameter is not met, after which the output from sensor 36 is read at step 76.

If the data read by IR sensor 36A (see FIG. 4) is an IR pulse that can be decoded as at step 78 such that data is present at step 80, a check to see if the data meets the program parameters is made at step 82. If program parameters are met and as shown at step 84, microcontroller 38 sends and/or receives and stores to memory in accordance with the program stored in the memory of the microcontroller 38, the method cycles back through counter/timer 72 and repeats. If the parameters are not met, the output from toggle relays on/off routine 68 (FIG. 7) is checked again at step 86 and the method cycles back through counter/timer 72 and repeats. If data is not present at step 80, the output from laser sensor 36B (see FIG. 4) is checked at step 88 and compared at step 90 to the third ambient reading/average from ambient light subroutine 70 (see FIG. 8). If less than the third ambient reading/average from ambient light subroutine 70, the method again cycles back through counter/timer 72, but if the output from laser sensor 36B is greater than the third ambient reading/average from ambient light subroutine 70 by a pre-selected margin, the output from the above-described toggle relays on/off routine 68 shown in FIG. 7 is checked as shown at step 86 and the method then cycles back through counter/timer 72.

Referring now to FIG. 7, the toggle relays on/off routine 68 is shown in detail. This routine 68 is intended for use with multiple lamp fixtures in which each lamp, or a set of two or more lamps, is switched independently of the other lamps by a respective relay 44 (see FIG. 4). However, those skilled in the art will recognize from this disclosure that routine 68 may also be used for switching multiple blower fans or other electrical appliances. A single light fixture may have four, six, eight, or more lamps with, for instance, ballasts (not shown in FIG. 7) for controlling two lamps each, two ballasts controlling two and four lamps each, three ballasts controlling three lamps each, three ballasts controlling two, four, and four lamps each, and so on. Each ballast is switched by a respective relay (not shown) such that the light output from the fixture depends on the number of lamps switched on, hence the reference herein to the use of the method and system of the present invention for step dimming a light fixture. Of course those skilled in the art will recognize that the fixture need not be a fluorescent fixture and that the present invention is also useful for step dimming an incandescent or metal halide light fixture with multiple lamps. The toggle relays on/off routine 68 starts with a query 92 for the presence of IR data as would be output from the IR sensor 36A described above. If no such data is present, a check is made as at 94 for a laser reading that meets the pre-set parameters of length and time and the routine 68 then continues by either turning off all relays 96, turning one relay on and others off 98, turning two relays on and the other off 100, turning three relays on 102, and so on in accordance with the pre-set parameters. If IR data is present, the data is decoded as at step 104 and the relays are turned on and/or off as described at steps 96, 98, 100, 102. Ballast position is then written to memory 106 and output to the main program as at step 68 (FIG. 6).

In another embodiment (not shown), one of the parameters utilized to control the system of the present invention is time, microcontroller 38 being programmed so that if the expected IR data or laser data is detected at step 92, 94 within a selected time period, for instance, ten seconds, the next signal detected switches the lamps in the fixture (or certain lamps or groups of lamps) off. Because the last operating state is written to memory as at step 106, when sensor 36A next detects a signal, the fixture is switched back to the last operating state, e.g., with 2, 4, 6, etc. lamps turned on.

Referring now to FIG. 8, the ambient light subroutine 70 is commenced by reading the output from ambient light sensor 58 (see FIG. 4) at step 108 and pausing for a predetermined interval (0.1 sec. in the case of the present embodiment), reading the output from ambient light sensor 58 a second time at step 110 and pausing again, then averaging the two readings at step 112. The output from ambient light sensor 58 is read a third time at step 114 and the third reading is compared to the average of the first two readings at step 116. If the third reading is equal to (or falls within a pre-set range relative to) the average of the first two readings, the reading is output to the main program as at step 70 (FIG. 6). If the third reading varies from the average of the first two readings, the routine 70 cycles back to step 108 on the assumption that the readings were caused by a flashing light or other light source that is not intended to constitute an input that changes the settings and/or operational status of microcontroller 38.

Referring now to FIG. 9, an alternative embodiment of a remote transmitter for use in connection with the present invention is indicated generally at reference numeral 132. Transmitter 132 is specifically intended for dimming functions in accordance with the method described in connection with FIG. 8, and is provided with a send/on button 134 and up/down selectors 162 for controlling operation of ten lamps in a fixture as described above, LED/indicator lights 138 providing visual confirmation of the operational status of the lamps in the fixture. A master off button 140 allows all the lamps in the fixture to be turned off with a single key stroke and, as described above, the operational status of transmitter 132 is written to memory so that when send/on button 134 is pressed again, the same number of lamps are illuminated. As described above, limiting divergence of the beam output by transmitter 132 is an important aspect of the ability of the switching system of the present invention to target an individual light fixture 18 or other appliance and the switching system of the present invention has been shown to have operating ranges of over 300 feet. At such operating ranges, the ability of the operator of the transmitter 132 to target an individual appliance is facilitated by the use of a sight that is integral with transmitter 132, a tubular sight 141 being shown for that purpose in FIG. 9 (of course transmitter 32 shown in FIG. 2 may also be provided with a visual alignment, or sighting, aid). Those skilled in the art will recognize that other visual sighting aids may take the form of a line or groove on the outside surface of remote 132, a pop-up peep sight, spotting scope, or even a laser source that is integral with transmitter 132.

A third embodiment of a switch controller for the point of use switching system of the present invention is shown schematically in FIG. 10. As with the embodiment shown in FIG. 4, the switch controller shown in FIG. 10 comprises detectors 36A and 36B that produce an output signal upon detection of either or both of an infrared or laser beam produced by a transmitter (not shown) such as the transmitter 32 shown in FIG. 2. Detector 36A produces an output signal to a first microcontroller 38A upon detection of an encoded infrared beam and detector 36B produces an output signal upon detection of an incident laser beam to second microcontroller 38B. Because a laser beam is so focused, the detector 36B is preferably comprised of an array of sensors 36B₁, 36B₂, and so on, each producing an output to microcontroller 38B, for ease of detection of an incident laser beam, especially when the transmitter is aimed at detector 36B from a long distance away. Microcontrollers 38A and 38B are connected, with microcontroller 38B receiving an output from microcontroller 38A depending upon whether an infrared beam has been detected by detector 36A, and microcontroller 38B functioning to switch an electrical appliance in the same manner as described above in connection with FIG. 2. The switch controller also includes the ambient light sensor 58 described above for producing an output to microcontroller 38B for adjusting sensitivity and is provided with EEPROM or other non-volatile memory 60 to which microcontroller 38B writes whenever a change in operating state occurs in the event of a loss of power, microcontroller 38B being programmed to check the non-volatile memory when it is powered up so as to return to the last operating state upon restoration of electrical power. If microcontroller 38B is programmed to return to the last operating state when power is restored, it may also be useful to delay the switching of the electrical appliance connected to relay 42 for the purpose of reducing peak power demand as described above. Those skilled in the art will recognize that a back-up battery can be provided for maintaining current operating state in the event of a loss of power rather than non-volatile memory.

RF module 146, current sensor 148, fan 150, and temperature sensor 152, and their respective inputs to microcontroller 38B, are also shown in FIG. 10. RF module 146 includes both a transmitter and a receiver and communicates with the RF module 154 on coordinator 156 (FIG. 11) for purposes described below. Current sensor 148 is interposed between the light fixture 18 or other appliance (labeled generically as the “load” in FIG. 10) and the microcontroller 38B to monitor and report the current drawn by fixture 18 (or more accurately, if the switch controller is being used to control a light fixture with multiple lamps, the relay 44 that switches the lamps on/off). The operation and function of current sensor 148, as well as fan 150 and temperature sensor 152, is discussed below.

Coordinator 156 is shown schematically in FIG. 11 and comprises a power supply 160 and microcontroller 158 that receives inputs from a keypad 164, the above-described RF module 154, and the devices attached to USB port(s) 166, serial port(s) 168, and/or ethernet port(s) 170. Coordinator 156 is also provided with a real time clock (RTC) 172 and battery back-up 174, and outputs information to LCD display 176 and memory 178 which, in one embodiment, is a flash memory device.

The operation and function of the switch controller shown in FIG. 10 and coordinator 156 shown in FIG. 11 will now be described with reference to FIGS. 12-17. Referring first to FIG. 12 showing the main program for the switch controller, the program starts at step 66 (the main program shown in FIG. 12 is in many respects identical in operation to the logic of the program for switch controller shown in FIG. 4 and diagrammed in FIG. 6, and the reference numerals for the steps common to both programs are therefore also utilized in FIG. 12) by reading the last status, or fixture configuration, and the last operating parameters provided by the network (see below). In the particular embodiment shown in FIG. 12, the control software includes software for dimming a light fixture in which multiple lamps are mounted as implemented by the toggle relays on/off routine 180 shown in FIG. 14 and described below. In the next step, the output from ambient light subroutine 70, shown in detail in FIG. 8 and described above, is read and counter/timer 72 is checked. If the counter parameter is met as at step 74, current is measured at step 182 by sampling the output from current sensor 148 (FIG. 10) and determining whether current is within the user-selected parameters at step 184. If fixture current (or the current drawn by the load switched in accordance with the present invention) is within user-selected operating parameters, temperature is measured at step 186 by sampling temperature sensor 152 and the method cycles through counter/timer 72 until the counter parameter is not met, after which the output from sensor(s) 36 is read at step 76. If fixture current is not within user-selected operating parameters at step 184, the current measurement from current sensor 148 is sent as at step 188 to coordinator 156 through the RF module 146 (see FIG. 10), temperature is measured at step 186, and the method cycles through counter/timer 72 as described in the preceding sentence.

If the data read at step 76 by IR sensor(s) 36 is an IR pulse that can be decoded as at step 78 such that data is present at step 80, a check to see if the data meets the program parameters is made at step 82. If program parameters are met and as shown at step 84, microcontroller 38 sends and/or receives and stores configuration data to memory and the method cycles back through counter/timer 72 and repeats. If user-selected parameters are not met at step 82, the program queries 190 all fixtures in a group (as selected and identified by user input) and sends a group request to coordinator 156 through RF module 146 at step 192 or ascertains whether the decoded IR pulse is for the same group at step 194. If not for the same group, the method cycles back through counter/timer 72 as described above. If for the same group, the output from the toggle relays routine (FIG. 14) is sampled at step 180 and the method cycles back through counter/timer 72. Returning to step 80, if data is not present, the output from laser sensor 36B is checked at step 88 and compared at step 90 to the third ambient reading/average from ambient light subroutine 70 (see FIG. 8). If less than the third ambient reading/average from ambient light subroutine 70, the method again cycles back through counter/timer 72, but if the output from laser sensor 36B is greater than the third ambient reading/average from ambient light subroutine 70 by a pre-selected margin, the output from toggle relays on/off routine shown in FIG. 14 is checked as at step 180 and the method cycles back through counter/timer 72.

The subroutine 73 for reading the RF module 146 of the switch controller 28 shown in FIG. 10 is diagrammed in FIG. 13. Subroutine 73 commences with a check for data at step 118; if no data is present, the subroutine returns to counter parameters query 74 of the controller main program (FIG. 12). However, if data is present, the RF module subroutine 73 checks at step 120 to determine whether the data specifies the particular group of fixtures to which the controller is mounted, in which case the subroutine 73 checks the toggle relays routine 180 as described below. If the data at step 120 is not data for the particular group to which the controller belongs, subroutine 73 continues by determining at step 122 whether the data is calling for a report of the status of the fixture to which the controller is mounted. If the data is a call for a status report, the subroutine 73 sends the identification code for the fixture, fixture status, and other functional information to the coordinator 156 via RF module 146 as at step 124. If the data is not a call for functional information, the subroutine 73 then determines at step 126 whether the data calls for a change in the configuration parameters of the fixture to which the controller is mounted, in which case the changed configuration is stored to the memory of microcontroller 38 as at step 128.

Referring now to FIG. 14, the toggle relays on/off routine 180 is shown in detail. This routine 180, which is identical in many steps to the routine 68 shown in FIG. 7 such that the same reference numerals are used to describe the steps common to both routine 68 (FIG. 7) and routine 180 (FIG. 14), is intended for use with multiple lamp fixtures in which each lamp, or a set of two or more lamps, is switched independently of the other lamps in the fixture by a respective relay 44 (see FIG. 10) (and those skilled in the art will recognize from this disclosure that routine 180 may also be used for switching multiple fan motors or other electrical appliances). A single light fixture may have four, six, eight, or more light lamps with, for instance, ballasts (not shown in FIG. 14) for controlling two lamps each, two ballasts controlling two and four lamps each, three ballasts controlling three lamps each, three ballasts controlling two, four, and four lamps each, and so on. Each ballast is switched by a respective relay (not shown) such that the light output from the fixture depends on the number of lamps switched on, hence the reference herein to the use of the method and system of the present invention for dimming a light fixture. Of course those skilled in the art will recognize that the fixture need not be a fluorescent fixture and that the present invention is also useful for dimming an incandescent or metal halide light fixture with multiple lamps. Just as with toggle relays on/off routine 68 (FIG. 7), toggle relays on/off routine 180 starts with a query 92 for the presence of IR data as would be output from the IR sensor 36A described above. If no such data is present, a check is made as at step 196 to determine whether a data value has been stored in memory, and if so, the routine 180 proceeds as described below. If not, a check is made as at step 94 for a laser reading that meets the pre-set parameters of length and time and the routine 180 then continues by either turning off all relays 96, turning one relay on and others off 98, turning two relays on and the other off 100, turning three relays on 102, and so on in accordance with the pre-set parameters and as described above in connection with the toggle relays 68 shown in FIG. 7. If IR data is present at step 92, the data is decoded as at step 104 and the relays are turned on and/or off as described at steps 96, 98, 100, 102. Ballast position is then written to memory 106 and fixture status is output to coordinator 156 at step 198 through RF module 146.

As described above in connection with toggle relays routine 68, in another embodiment, a parameter that can also be utilized for controlling the method of the present invention is time, microcontroller 38 being programmed so that if the expected IR data or laser data is detected at step 92, 94 within a selected time period, the next signal detected switches the lamps in the fixture (or certain lamps or groups of lamps) off. That same embodiment is likewise capable of implementation with the toggle relays routine 180 shown in FIG. 14. Just as with toggle relays routine 68, because the last operating state is written to memory as at step 106, the fixture is switched back to the last operating state, e.g., with 2, 4, 6, etc. lamps turned on when sensor 36A next detects a signal.

The subroutine for the measure temperature step 186 of the main program (FIG. 12) for switch controller 28 is set out in more detail in FIG. 15. If the temperature (measured by sampling the output from temperature sensor 152 (FIG. 10)) is higher than the user-set temperature limit at 200, the fan 150 (FIG. 10) is switched on at step 202. Temperature is then compared to a user-selected operating range at step 204 and if the temperature falls within those operating parameters, the routine returns to the main program (FIG. 12). If measured temperature is outside the user-selected operating parameters at step 204, an alert is sent to coordinator 156 via RF module 146 at step 206. If the measured temperature is below the user-selected temperature limit at step 200, fan 150 is switched off at step 208 and the routine returns to the main program.

The logic diagram for a first embodiment of a main program for coordinator 156 is shown in FIG. 16. The program starts by initializing the peripherals, including keypad, USB port, serial port, and ethernet port 164-170 and LCD display 176 (all as shown in FIG. 11) at 210 and reading configuration network parameters in accordance with the network parameters routine shown in FIG. 13 and described above as at step 212. A check is made at 214 for the settings and functions obtained from the network parameters routine and, if such settings and functions are obtained, keypad 164 is checked for user input at 216, group, temperature, current level, and network parameters are stored to memory and any pre-programmed utilities are executed at step 218. The method then cycles continually back to the check settings/functions step 214.

If no settings/functions are detected at step 214, RF module 154 is checked for input at step 220. The input from RF module 154 can take several forms, one of which is a group request, and if a group request is present at step 222, group status is broadcast to all fixtures via RF module 154 (more accurately, to the RF module 146 of each switch controller 28 mounted on each appliance to be switched) at 224 to poll fixture status 226. The routine then cycles back to the settings/functions step 214. If a group request is not present at step 222, a check is made for fixture status data at step 228 and, if such data is present, the real-time clock (RTC) 172 (see FIG. 11) is read at step 230 and the time-stamped fixture status information is stored to memory at step 232. In one embodiment, the time-stamped fixture status information is stored to the memory 178 of coordinator 156. Additionally, data is stored to memory 178 and a USB flash drive inserted into the USB port 166 of coordinator 156 or stored to either of memory 178 and USB flash drive and sent, via ethernet port 170, to a remote system administrator (not shown) as described below. The routine then cycles back to the settings/functions step 214.

If fixture status data is not present at step 228, a check is made for current measurement(s) at step 234. If current measurement(s) are present, the RTC is read at step 236, the time-stamped data is stored to memory at step 237, and the routine cycles back to settings/functions step 214. If no current measurement(s) are present at step 234, the routine next checks at step 238 for any temperature alerts (see step 206, FIG. 15) and, if alerts are found, implements specific user-input rule(s) for addressing such alerts at step 240, and stores the date, time, and temperature to memory at step 242. The routine then cycles back to settings/functions step 214. If no temperature alerts are found at step 238, serial and/or ethernet ports 168, 170 are read at step 244 to see if communication has been established with the system administrator as at 246. If communication has been established, operational information is exchanged with the system administrator at step 248 and the routine cycles back to settings/functions step 214; if communication has not been established, the routine also cycles back to the clock settings/functions step 214.

Referring to FIG. 17, the polling fixture status step 226 described above is shown in more detail. In this subroutine, an inquiry is sent via RF module 154 of coordinator 156 to the RF module 146 of the switch controller 28 of each fixture at step 250. The RTC 172 is read at 252 and the date/time-stamped response from each fixture is then stored to memory 178, and/or to USB drive inserted into USB port 166 (or both), or stored to memory 178 at step 254. If all fixtures have not been polled at step 256, the subroutine cycles back to the poll fixture status step 226; if all fixtures have reported, the subroutine returns to the main program (FIG. 16).

As noted at several points in the preceding paragraphs, the present invention contemplates the exchange of operational information between coordinator 156 and a system administrator (as well as the exchange of functional information between coordinator 156 and each of the switch controllers 28 mounted to the fixtures to be controlled in accordance with the present invention). In one embodiment, the system administrator takes the form of a computer in communication through USB port 166, serial port 168, or ethernet port 170. When provided with appropriate software, the system administrator analyzes the operational information received from coordinator 156 and enables a top level control of the fixtures in the network from a centralized (or remote) location, changing the user-programmed rules for action when, for instance, a temperature or current alert is received at the coordinator, changing the set temperature or user-selected temperature range, and controlling the many other operations of the system of the present invention. The exchange of operational information between system administrator and coordinator 156 also enables the accumulation (and reporting) of information that enables the planning of maintenance and/or scheduling of lamp/ballast replacement. Note also that this exchange of information is also made possible by removing the flash drive from the USB port 168 of coordinator 156 and transferring the data stored on the flash drive to a computer such that at least some network functions are enabled even in the absence of a hardwired or wireless network. Of course this latter capability illustrates the ability of the system and method of the present invention to function without the system administrator while still providing data useful for, for instance, validating a component manufacturer's warranty (ballasts are, for instance, warranted for a specified number of hours of operation as long as certain temperature ranges are maintained), verifying a reduction in power consumption such as might be governmentally mandated and/or voluntarily implemented by a utility customer in times of high power demand, or for the many other uses of such information.

In short, those skilled in the art who have the benefit of this disclosure will recognize that the point of use switching system of the present invention provides opportunities for operating flexibility that, on information and belief, are not available in previously known remote switching systems. For instance, with the ability to produce an encoded signal and the addition of a transmitter mounted to a light fixture to be switched with the present system, the remote transmitter can switch multiple light fixtures. For instance, the transmitter can be set to a dedicated position for producing an encoded, targeted output signal that is detected by a switch controller 28 mounted on a specific light fixture to cause that specific light fixture to switch on/off. The microcontroller 38 in the switch controller 28 of that specific light fixture may be pre-programmed to produce an output signal to a transmitter that, like switch controller 28, is mounted to that specific light fixture and that produces an output signal targeted to a second specific light fixture at some location to cause that second specific light fixture to turn on/off. Likewise, the second specific light fixture may be provided with a transmitter for producing an output signal for activating a third specific light fixture and so on, and any one or more of the fixtures in such a sequence may be provided with timer(s) for switching the fixture(s) after a pre-selected period of time. Those skilled in the art will recognize that the output from the microcontroller 38 in the switch controller 28 mounted to the first specific light fixture may be delayed so that the second specific light fixture is switched, and that the transmitter on the second may likewise be delayed so that the third specific light fixture is switched, in sequence (relative to the first and second specific light fixtures) for such purposes as security or for following the movements of personnel through a building. Of course a specific fixture may have two or more transmitters mounted to that fixture for activating more than one additional light fixture. Because the output signal from the transmitter mounted on each specific fixture is targeted to the sensor(s) on second (and subsequent) specific fixture(s), other light fixtures are not switched when the first specific fixture is switched and the fixture-mounted transmitter on the first specific fixture produces an output signal. Those skilled in the art will recognize that the switching system of the present invention enables other operational possibilities. Another use of this “repeater” function for turning specific light fixtures on in sequential fashion is for the purpose of reducing peak load. In other words, as described above, in certain installations, a portion of the billing to the operator of the installation for power consumption is based on the peak load of that installation. Because power consumption peaks when electrical appliances are switched from off to on, peak consumption can be reduced by switching appliances on in sequential fashion rather than simultaneously, thereby helping to control the cost of operating those appliances.

Those skilled in the art who have the benefit of this disclosure will also recognize that certain changes can be made to the component parts of the apparatus of the present invention without changing the manner in which those parts function and/or interact to achieve their intended result. By way of example, those skilled in the art who have the benefit of this disclosure will recognize that (although not shown in the figures) it is useful to provide microcontroller 38 with an output to an LCD or other digital readout for diagnostic and/or programming purposes. It will also be recognized that it may be useful to provide a manually-activated switch on switch controller 28 for switching a light fixture during installation of the fixture, switch controller 28, and/or testing purposes. All such changes, and others that will be clear to those skilled in the art from this description of the preferred embodiment(s) of the invention, are intended to fall within the scope of the following, non-limiting claims.

What is claimed is:

1. A system for switching an electrical appliance comprising:
a transmitter for selectively producing a directional output signal;
a receiver having a sensor for detecting the directional output signal from said transmitter, said receiver producing an output signal when the directional output signal from said transmitter is detected by the sensor;
a switch controller comprising a microcontroller and a connector, said connector being adapted for operably connecting said microcontroller to an electrical appliance, the microcontroller receiving the output signal from said receiver and outputting a signal to the electrical appliance through said connector for switching the electrical appliance; and
a coordinator communicating with said switch controller for verifying and storing the status of the electrical appliance to memory and for controlling said switch controller in accordance with user-selected configuration parameters.

2. The switching system of claim 1 wherein said switch controller is mounted to the electrical appliance.

3. The switching system of claim 1 wherein said transmitter produces either a laser or a low divergence infrared output signal when activated.

4. The switching system of claim 1 wherein said receiver is provided with sensors for recognizing infrared and laser output signals from said transmitter.

5. The switching system of claim 1 wherein said microcontroller is programmed to output a signal to the connector after a time delay during which the sensor detects the encoded directional output signal.

6. The switching system of claim 1 additionally comprising means for limiting divergence of the signal output from said transmitter.

7. A system for switching an electrical appliance comprising:
a sensor presenting a target of relatively small size;
a remote for transmitting a signal in the form of a low divergence beam for aiming at said sensor and encoding a signal for receipt by said sensor;
a microcontroller for receiving an output from said sensor when said sensor detects a signal from said transmitter, said microcontroller being programmed to produce an output for switching an electrical appliance upon receipt of the output from said sensor; and
a coordinator for sending operational information to and from said microcontroller for verifying the operating state of said electrical appliance, storing operational information to memory, and changing the configuration parameters of said microcontroller.

8. The switching system of claim 7 wherein said microcontroller is programmed not to produce an output for switching an electrical appliance unless more than one output is received from said sensor within a pre-selected period of time.

9. The switching system of claim 7 additionally comprising an ambient light sensor for producing an output to said microcontroller, said microcontroller being programmed to produce an output to the switching device for switching an electrical appliance depending upon the level of ambient light.

10. The switching system of claim 7 wherein said microcontroller is programmed to ignore signals from said sensor when said sensor detects an encoded signal from said transmitter either for a selected period of time or until receipt of a second encoded signal from said transmitter.

11. A method of switching an electrical appliance comprising the steps of:
producing a directional output signal by limiting the divergence of the signal output from a transmitter;
aiming the directional output signal from the transmitter at a sensor located on an electrical appliance;
outputting a signal from the sensor when the sensor detects the output signal from the transmitter;
outputting a signal from a microcontroller upon receipt of the output signal from the sensor by the microcontroller;
activating a switching device upon receipt of the output signal from the microcontroller to switch the electrical appliance; and
verifying the switching of the electrical appliance and storing the operational status of the electrical appliance to memory.

12. The method of claim 11 in which the microcontroller outputs a signal to the switching device only when the sensor detects multiple signals within a pre-selected period.

13. The method of either of claim 11 additionally comprising the step of encoding the directional signal output from the transmitter to cause the microcontroller to operate in one or more pre-programmed modes.

14. The method of claim 11 wherein one of the encoded signals causes the microcontroller to ignore signals from the sensor either for a pre-programmed period of time or until the sensor again detects the same encoded signal.

15. The method of claim 11 additionally comprising adjusting sensitivity in response to changes in ambient light.

16. The method of claim 11 additionally comprising the step of switching the electrical appliance off after a pre-selected period of time.
